(19) United States
(12) Patent Application Publication
(10) Pub. No.: US 2009/0240842 A1
(43) Pub. Date: Sep. 24, 2009

(54) PORTABLE ELECTRONIC APPARATUS

(75) Inventors: HAN-CHE WANG, Tu-Cheng (TW); SHIH-TSAI LIU, Tu-Cheng (TW); HSIN-NAN HU, Tu-Cheng (TW); KUAN-HONG HSIEH, Tu-Cheng (TW); RUEY-SHYANG YOU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/344,573

(22) Filed: Dec. 28, 2008

(30) Foreign Application Priority Data
Mar. 21, 2008 (CN) 200810066157.9

(51) Int. Cl. G06F 3/00

(52) U.S. Cl. 710/14

(57) ABSTRACT

The present invention provides a portable electronic apparatus. The portable electronic apparatus includes an input unit, a first controller, a second controller, a human interface device (HID), and a switch unit. The input unit generates input signals from a user. The first controller performs a first group of functional applications and generates a first group of functional interfaces. The second controller performs a second group of functional applications and also generates a second group of functional interfaces. The HID receives the input signals generated from the input unit and generates a control instruction. The switch unit receives the control instruction from the HID to switch between the first controller and the second controller. Accordingly, the first controller and the second controller perform corresponding functions.

### TECHNICAL FIELD

The disclosure relates to portable electronic apparatuses and, more particularly, to a portable electronic apparatus including two controllers.

### GENERAL BACKGROUND

Portable electronic apparatuses usually have multiple functional applications, for example, a mobile phone not only has a short messaging service (SMS) function and a call function, but also has a audio/video playing function and a communications function via wireless fidelity (WIFI) technology. Commonly, an audio/video processing module and a WIFI module are integrated in a main central processing unit (CPU) of the mobile phone. However, over-integration of operations degrades the processing ability of the main CPU by slowing down the processing speed of the main CPU. Therefore, integration operations and new functions bring a lot of burden for the developer and lead to a lower work capability of the main CPU.

Accordingly, what is needed in the art is a portable electronic apparatus including two controllers that overcomes the aforementioned deficiencies.

### BRIEF DESCRIPTION OF THE DRAWINGS

The components in the drawings are not necessarily drawn to scale, the emphasis instead being placed upon clearly illustrating the principles of the portable electronic apparatus. Moreover, in the drawings, like reference numerals designate corresponding parts throughout the several views.

FIG. 1 is a block diagram of a hardware infrastructure of a portable electronic apparatus in accordance with an exemplary embodiment.

FIG. 2 is an exemplary block diagram of the portable electronic apparatus of FIG. 1 in accordance with an exemplary embodiment.

FIG. 3 is a schematic interface view of the portable electronic apparatus of FIG. 1 in accordance with an exemplary embodiment.

### DETAILED DESCRIPTION OF THE EMBODIMENTS

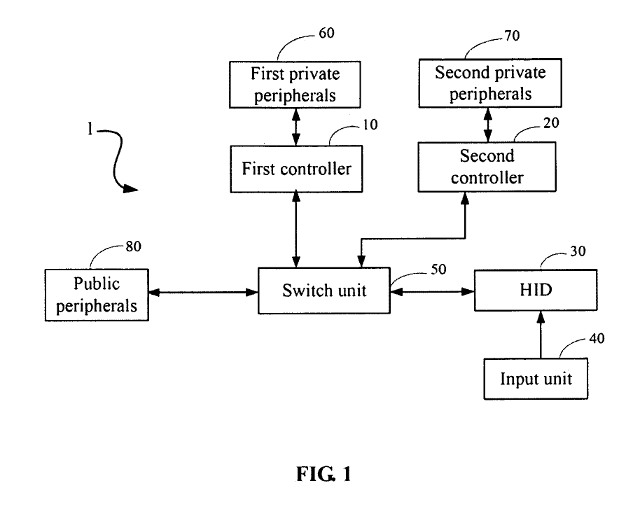

FIG. 1 is a block diagram of a hardware infrastructure of a portable electronic apparatus in accordance with an exemplary embodiment. The portable electronic apparatus 1 (hereinafter “the apparatus 1”) includes a first controller 10, a second controller 20, a human interface device (HID) 30, an input unit 40, a switch unit 50, first private peripherals 60, second private peripherals 70, and public peripherals 80.

The first controller 10 is configured for performing a first group of functional applications and generating a first group of functional interfaces. The first private peripherals 60, connected to the first controller 10, are configured for receiving controls from the first controller 10. The second controller 20 is configured for performing a second group of functional applications and generating a second group of functional interfaces. The second private peripherals 70, connected to the second controller 20, are configured for receiving controls from the second controller 20. The input unit 40 is configured for generating input signals from a user. The HID 30 is configured for processing the input signals from the input unit 40 and generating a control instruction.

The switch unit 50, connected to the HID 30, is configured for responding to the control instruction from the HID 30 to switch between the first controller 10 and the second controller 20, thereafter the first controller 10 and the second controller 20 perform corresponding functional applications. The switch unit 50 includes a plurality of switch circuits (not shown). For example, when the HID 30 generates a first control instruction, the switch unit 50 switches from the first controller 10 to the second controller 20 and the second controller 20 performs the second group of functional applications; when the HID 30 generates a second control instruction, the switch unit 50 switches from the second controller 20 to the first controller 10 and the first controller 10 performs the first group of functional applications.

The public peripherals 80, connected to the switch unit 50, are configured for receiving controls between the first controller 10 and the second controller 20. For example, when the switch unit 50 switches from the functional interfaces of the first controller 10 to the functional interfaces of the second controller 20, the second controller 20 controls the public peripherals 80 and the first controller 10 stops controlling the public peripherals 80; when the switch unit 50 switches from the functional interfaces of the second controller 20 to the functional interfaces of the first controller 10, the first controller 10 controls the public peripherals 80 and the second controller 20 stops controlling the public peripherals 80.

In an exemplary embodiment, the first controller 10 is a media player controller, such as a moving picture experts group audio layer3 (Mp3) controller, a moving picture experts group audio layer4 (Mp4) controller, and the like, for performing functional applications of playing media files. The second controller 20 is a mobile communications controller, such as a global system for mobile communications (GSM) controller, a general packet radio service (GPRS) controller, a code division multiple access (CDMA) controller, and the like, for performing functional applications of communications via wireless protocol.

In another exemplary embodiment, the first controller 10 is a wireless fidelity (WIFI) controller, for performing WIFI communications functional applications, and the second controller 20 is another mobile communications controller for performing functional applications of communications via wireless protocol. In other exemplary embodiments, the first controller 10 and the second controller 20 can be further added new functional applications if necessary.

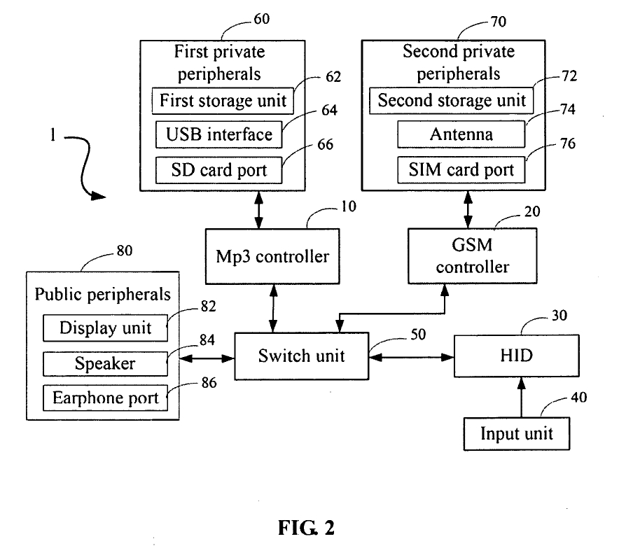

FIG. 2 is an exemplary block diagram of the portable electronic apparatus of FIG. 1 in accordance with an exemplary embodiment. In the exemplary embodiment, the first controller is an Mp3 controller 10, and the second controller is a GSM controller 20. The apparatus 1 includes two work modes, e.g., an Mp3 work mode and a GSM work mode. The Mp3 controller 10 works in the Mp3 work mode, and the GSM controller 20 works in the GSM work mode.

The first private peripherals include a first storage unit 62, a universal serial bus (USB) interface 64, and a secure digital (SD) card port 66. The first storage unit 62 is configured for storing programs of functional applications of the first controller 10 and media contents. The media contents include, but are not limited to, a plurality of Mp3 audio files. The second private peripherals include a second storage unit 72, an antenna 74, and a subscriber identity module (SIM) 76. The second storage unit 72 is configured for storing programs of functional applications of the second controller 20 and communication data. The communication data include, but are not limited to, a plurality of short messages and a phonebook.

The public peripherals 80 include a display unit 82, a speaker 84, and an earphone port 86. When the switch unit 50 switches from one controller to the other controller, the display unit 82 switches from functional interfaces of one controller to functional interfaces of the other controller. For example, when the apparatus 1 enters the Mp3 work mode, the Mp3 controller 10 controls the display unit 82 to display the Mp3 player interface, the speaker 84 to output sound corresponding to an audio file, and the earphone port 86 to receive the audio signals for an earphone (not shown). When the apparatus 1 enters the GSM work mode, the GSM controller 20 controls the display unit 82 to display the functional interfaces of short messages and phonebook, the speaker 84 to output a ring tone when the antenna 74 receives an incoming call signal from an external wireless communications system (not shown), and the earphone port 86 to receive voice from a called party for the earphone.

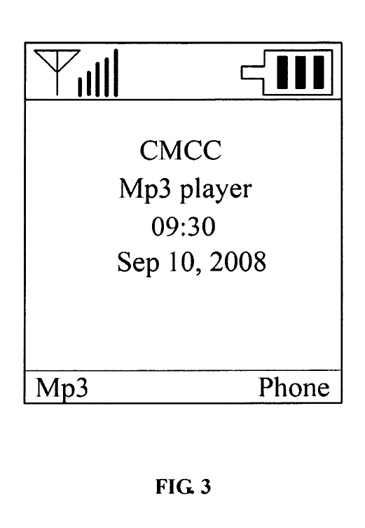

When the HID 30 receives a turn-on input signal from the input unit 40, the display unit 82 displays a public functional interface. For example, in the exemplary embodiment as shown in FIG. 3, the public functional interface is configured for displaying basic information of the apparatus 1 when the apparatus 1 is in a standby state, for example, signal strength, battery capacity, current time and date (e.g., 09:30 am, and Sep. 10, 2008), a service provider of the apparatus 1 (e.g., China Mobile Communication Corporation (CMCC)), and a media player function (e.g., Mp3 player). The public functional interface further provides two optional icons corresponding to the two work modes for entering the two work modes. In addition, when the apparatus 1 is in the standby state, the GSM controller 20 is in a standby state and the Mp3 controller 10 is in an inactivate state.

When the HID 30 receives an instruction for entering the Mp3 work mode in response to a press operation on the Mp3 icon from the input unit 40, the switch unit 50 switches the apparatus 1 to the Mp3 work mode, thereafter the Mp3 controller 10 enters an active state, and performs corresponding functional applications, for example, playing an Mp3 audio file. Furthermore, in the Mp3 work mode, the first private peripherals 60 and the public peripherals 80 also enter the activate state. For example, when the input unit 40 receives a play operation, the Mp3 controller 10 fetches an audio file from the first storage unit 62 and controls the speaker 84 to output sound, and the display unit 82 displays the play interface.

When the HID 30 receives an instruction for entering the GSM work mode in response to an input operation on the Phone icon from the input unit 40, the switch unit 50 switches the apparatus 1 to the GSM work mode, thereafter, the GSM controller 20 enters an activate state, and performs corresponding functional applications, for example, writing a short message. Furthermore, in the GSM work mode, the second private peripherals 70 and the public peripherals 80 also enter the activate state as well as the GSM controller 20. For example, when the input unit 40 receives a calling operation, the GSM controller 20 controls the antenna 74 to outgo a call, and the display unit 82 displays the calling interface.

When the antenna 74 receives an incoming call signal from the external wireless communications system while the apparatus 1 is playing an audio file, the Mp3 controller 10 stops playing the audio file, and the switch unit 50 switches the current work mode from the Mp3 work mode to the GSM work mode, that is, the switch unit 50 switches the controller of the apparatus 1 from the Mp3 controller 10 to the GSM controller 20, thereafter, the Mp3 controller 10 enters the inactivate state, and the GSM controller 20 enters the activate state and controls the speaker 84 to output a ring tone.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A portable electronic apparatus comprising:
an input unit configured for generating input signals from a user;
a first controller configured for performing a first group of functional applications and generating a first group of functional interfaces;
a second controller configured for performing a second group of functional applications and generating a second group of functional interfaces;
a human interface device (HID) configured for processing the input signals from the input unit and generating a control instruction; and
a switch unit configured for responding to the control instruction from the HID to switch between the first controller and the second controller.

2. The portable electronic apparatus as recited in claim 1, further comprising:
first private peripherals capable of receiving controls from the first controller;
second private peripherals capable of receiving controls from the second controller; and
public peripherals, connected to the switch unit, capable of receiving controls from the first controller and the second controller.

3. The portable electronic apparatus as recited in claim 1, wherein the first controller is a media player controller for performing functional applications of playing audio/video media files, and the second controller is a mobile communications controller for performing functional applications of communications.

4. The portable electronic apparatus as recited in claim 3, wherein the media player controller is an Mp3, or an Mp4 controller, and the mobile communications controller is a GSM, GPRS, or CDMA controller.

5. The portable electronic apparatus as recited in claim 1, wherein the first controller is a wireless fidelity (WIFI) controller for performing WIFI communications functional applications, and the second controller is another mobile communications controller for performing functional applications of communication via wireless protocol.

6. The portable electronic apparatus as recited in claim 5, wherein the second controller is a GSM, GPRS, or CDMA controller.

7. The portable electronic apparatus as recited in claim 1, wherein the switch unit comprises a plurality of switch circuits.

8. The portable electronic apparatus as recited in claim 1, wherein the first controller works in a first work mode, and the second controller works in a second work mode.

9. The portable electronic apparatus as recited in claim 8, wherein when the input unit generates a turn-on input signal, the apparatus displays a public functional interface for displaying basic information of the apparatus when the apparatus is in a standby state, and the basic information comprises signal strength, battery capability, current time and date, and two optional icons for entering the two work modes.

10. The portable electronic apparatus as recited in claim 2, wherein the first private peripherals comprise a first storage unit for storing programs of functional applications of the first controller.

11. The portable electronic apparatus as recited in claim 2, wherein the second private peripherals comprise a second storage unit for storing programs of functional applications of the second controller.

12. The portable electronic apparatus as recited in claim 2, wherein the public peripherals comprise a display unit for displaying functional interfaces; when the switch unit switches from one controller to the other controller, the display unit switches from functional interfaces of one controller to functional interfaces of the other controller.
